(19) United States
(12) Patent Application Publication
(10) Pub. No.: US 2002/0168953 A1
(43) Pub. Date: Nov. 14, 2002

(54) Frequency scanning receiver

(76) Inventors: Sadanori Shitara, Tokyo (JP); Kiyoshi Wakui, Tokyo (JP); Nobuaki Yokoyama, Tokyo (JP)

Correspondence Address: FLYNN, THIEL, BOUTELL & TANIS, P.C., 2026 Rambling Road, Kalamazoo, MI, 49008-1699, US

(21) Appl. No.: 10/139,944

(22) Filed: May 6, 2002

(30) Foreign Application Priority Data
May 11, 2001 (JP) 2001-141607

(51) Int. Cl. H04B 1/18

(52) U.S. Cl. 455/161.1; 455/196.1; 455/316

(57) ABSTRACT

A frequency scanning receiver comprises a first local oscillator, a second local oscillator, a Nth local oscillator, a memory, a control circuit and etc.

In said memory, data of a predetermined frequency deviation from a reference frequency set in said first local oscillator is stored. The control circuit controls a frequency of a local carrier wave of said second local oscillator in accordance with said data when a wave to be received has said predetermined frequency deviation from said reference frequency.

### BACKGROUND OF THE INVENTION

1. Field of the Invention

The present invention relates to a frequency scanning receiver used in the VHF (Very High Frequency) band, UHF (Ultra High Frequency) band or the like, and particularly relates to an improvement of methods of setting a frequency of local carrier wave for converting a frequency.

2. Description of the related art

Radio waves used in the VHF band, usually, are allocated so as to be at the intervals of 15 kHz, and in the UHF band, radio waves are allocated so as to be at the intervals of 12.5 kHz. However, although radio waves are allocated at the intervals of 15 kHz, there are a number of groups of radio waves here and there which do not have any multiple relationship with 15 kHz such that these are not evenly allocated at the intervals of 15 kHz over its whole band, there is a group consisted of some radio waves which are allocated at the intervals of 15 kHz, then, there is another group consisted of some radio waves which are allocated at the intervals of 15 kHz but away from the group at the distance of 20 kHz×N. It is also similar circumstances concerning with the frequency band at the intervals of 12.5 kHz. Moreover, resulting from the shortness of radio waves {radio resources or radio propagation paths}, the 15 kHz interval of the VHF band is shifting to 7.5 kHz interval and the 12.5 kHz interval of the UHF band is shifting to 6.25 kHz interval.

In what is called a full wave scanning receiver for covering radio waves at the intervals over such a wide band, it is a well-worn device that a first local oscillator controlled by a PLL (Phase Locked Loop) for channel selection (tuning) is used. Since a frequency signal of an integer-fold of the reference oscillation frequency by the reference oscillator (crystal oscillator) can be outputted by controlling a dividing ratio of a frequency divider constituting the PLL, a stable scanning first local oscillator can be configured.

However, in the case where it would have been really applied, the following inconveniences will occur: since in the receiver as configured above, only a frequency signal of an integer-fold of the reference frequency can be outputted, the reference frequency of the first local oscillator is required to set the greatest common divisor of the full receiving frequency (precisely, a frequency as a first local oscillation, but it is similar to a receiving frequency), however, at the present time, radio waves are allocated in miscellaneous arrays of frequency intervals as described above, therefore, it cannot help selecting the reference frequency being extremely low such as 2.5 kHz, 3.125 kHz or the like. If the reference frequency is lowered, the cut-off frequency of the loop filter of the PLL corresponding to this frequency cannot help being also lowered, necessarily, the response of the PLL will be delayed, and it will take a considerable time to set the receiving frequency at the time of channel selection.

### SUMMARY OF THE INVENTION

Hence, an object of the present invention is to provide a frequency scanning receiver capable of setting a receiving frequency at the time of channel selection, not requiring the time for setting the reference frequency of a PLL and in a simple circuit configuration.

In order to achieve the object, the present invention contrives the point that in a frequency scanning receiver having a first local oscillator using a PLL (Phase Locked Loop), a second local oscillator, a Nth local oscillator (N denotes a positive integer), a frequency discriminator and the like, it is equipped with control means for controlling a frequency of a local carrier wave of said second or Nth local oscillator in accordance with a predetermined frequency deviation (error) from a reference frequency set in said first local oscillator when a wave to be received has said predetermined frequency deviation from said reference frequency.

In the present invention, the control means may be configured by a memory for storing data of said predetermined frequency deviation.

### BRIEF DESCRIPTION OF THE DRAWING

The accompanying drawing, which is incorporated in and constitute a part of the specification, illustrate presently preferred embodiments of the invention, and together with the general description given above and the detailed description of the preferred embodiments given below, serve to explain the principles of the invention, wherein:

FIG. 1 is a diagram of a circuit configuration showing one embodiment of the present invention.

### DESCRIPTION OF THE PREFERRED EMBODIMENTS

Although it is better that the reference frequency of a PLL is as high as possible from the viewpoint of the setting time, if the higher frequency is chosen, since the frequency interval of output carrier wave is widened, by that portion, the number (kinds of errors) of the first IF (first immediate frequency) signal having a frequency error is increased, and if a lower frequency is chosen, on the contrary, the number of the kinds of errors decreases, but the problem of the setting time emerges. Hence, now, supposing that the reference frequency is made on the order of 7.5 kHz or 6.25 kHz, and if a radio wave actually used is channel-selected and received, the number of the kinds of error frequencies is about 3 to about 5. If it is selected so that the frequency of the second local oscillator becomes zero with respect to this first IF signal, corresponding to the error frequency, it is to be a correct frequency in the second IF.

A frequency of a carrier wave of each broadcast station is predetermined and known. Therefore, when a broadcast wave is received by using a first local oscillator having a reference frequency of 5.0, 6.25 or 7.5 kHz to select a frequency of said wave, a frequency deviation (error) of the selected frequency from the reference frequency is predetermined and known. So, when said wave is received, correct receiving can be done by changing a frequency of a second local oscillator by said frequency deviation. In order to do so, a normal reference frequency is set in the first local oscillator and a control circuit controls a frequency of the second local oscillator in accordance with a frequency deviation (error) correcting value (data) stored in a memory which is one to change the frequency of the second local oscillator so as to cancel said frequency deviation. If it is such a configuration, the increases of the scale of the circuit is not expected to be so large.

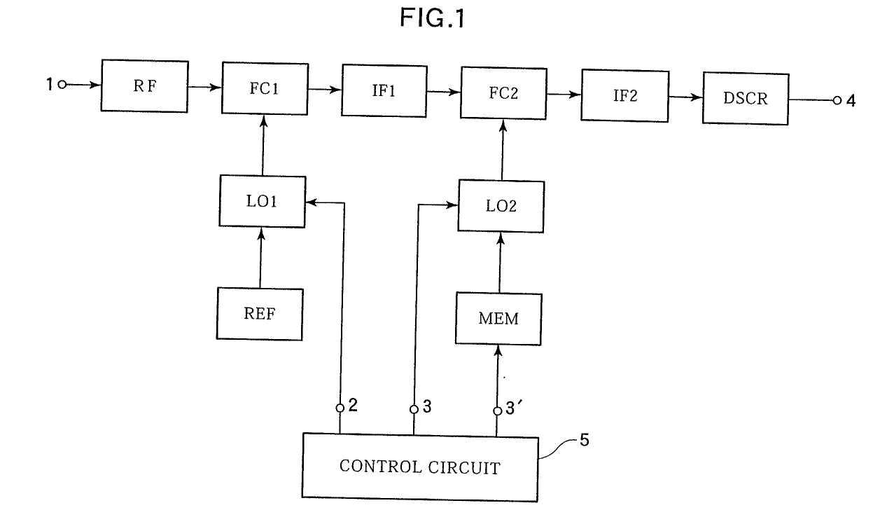

One embodiment of a frequency scanning receiver of the present invention will be described using the following drawings. FIG. 1 is a diagram showing a circuit configuration of this embodiment. In FIG. 1, the reference numeral 1 denotes an input terminal for a high frequency signal, RF denotes a high frequency amplifier, FC1 denotes a first frequency converter, LO1 denotes first local oscillator, REF denotes a reference signal generator, 2 denotes a reference frequency setting signal input terminal of the first local oscillator LO1, IF1 denotes a first intermediate frequency amplifier (fist IF amplifier), FC2 denotes a second frequency converter, LO2 denotes a second local oscillator, 3 denotes a reference frequency setting signal input terminal of the second local oscillator LO2, 3′ denotes an input terminal of a control signal for doing frequency setting of the second local oscillator with a memory (MEM) output, IF2 denotes a second intermediate frequency amplifier (second IF amplifier), DSCR denotes a frequency discriminator, 4 denotes a demodulated signal output terminal and 5 denotes a control circuit for supplying a frequency setting signal of LO1 and a control signal of LO2 to terminals 2, 3 and 3′.

A high frequency signal given to the input terminal 1 at the time of channel selection (tuning) is added to the first frequency converter FC1 through the high frequency amplifier RF, and the frequency is converted to the first IF in the first frequency converter FC1 using the local carrier wave outputted from the first local oscillator LO1. The first local oscillator LO1 is controlled by PLL described above and outputs a first local carrier wave of the frequency of an integer-fold of the reference frequency (for example, 7.5 kHz) added by the reference signal generator REF. How many integer-fold the frequency is multiplied by the reference frequency is determined by controlling the frequency dividing ratio of the divider within the PLL using a setting signal added by the terminal 2. The signal converted to the first intermediate frequency (first IF) is added to the second frequency converter FC2 through the first IF amplifier IF1, where it becomes a second IF signal using a second local carrier wave outputted from the second local oscillator LO2. This signal is added to the frequency discriminator DSCR through the second IF amplifier IF2 and demodulated.

Since initially, the second local oscillator LO2 is controlled so that a second local carrier wave of the normal frequency is outputted, in the case where a radio wave having a frequency of an integer-fold of 7.5 kHz (in this case) is received, the output of the frequency discriminator DSCR is zero because there is no frequency error. However, as described above, since there are radio waves having a frequency of +2.5 kHz or −2.5 kHz or the like deviated from the frequency of an integer-fold of 7.5 kHz, when these radio waves are received at the time of channel selection, the control circuit 5 controls frequency setting of the second local oscillator LO2 by the control signal. That is, in order to receive said radio waves, data of frequency deviation of each waves from the reference frequency of LO1 is preset in the memory MEM and is read out by the control signal to change the frequency of LO2 to an appropriate frequency in accordance with said data so that the frequency deviation becomes zero. Therefore, when the setting data of the PLL of the first local oscillator LO1 is given, since the frequency of the second local oscillator LO2 is immediately set through the memory MEM by the control signal, concerning with the timing, the second local oscillator LO2 is set faster than the first local oscillator LO1.

As described above, all of the frequencies except for frequency of an integer-fold of the reference frequency of the PLL have been described so that these frequencies are coped with the second local oscillator LO2, however, needless to say, in the case where the third local oscillator has been provided, these frequencies may be coped with the third local oscillator.

As described above in detail, in the case where radio waves of the VHF and UHF bands are received and channel-selected by a frequency scanning receiver using a first local oscillator by means of a PLL, the reference frequency of the PLL of the first local oscillator is required to be selected so as to be the greatest common divisor for all of the frequencies within the covering range. However, since all of the actual radio waves are not allocated in equal intervals, it cannot help necessarily selecting lower reference frequencies, as a result of this, it requires the time for setting the PLL. However, according to the present invention, since the PLL can be designed as the frequencies of the received radio waves being allocated at an equal interval, the reference frequency can be set at a higher frequency, and the setting time of the PLL can be made shortened.

What is claimed is:

1. A frequency scanning receiver comprising a first local oscillator having a phase locked loop, a second local oscillator, a Nth local oscillator and a frequency discriminator and etc.,
said receiver including control means for controlling a frequency of a local carrier wave of said second or Nth local oscillator in accordance with a predetermined frequency deviation from a reference frequency set in said first local oscillator.

2. A frequency scanning receiver according to claim 1, wherein said control means includes a memory for storing data of said predetermined frequency deviation.
